(19) United States
(12) Patent Application Publication
(10) Pub. No.: US 2007/0143450 A1
(43) Pub. Date: Jun. 21, 2007

(54) System and method for web-based monitoring and control of a plurality of spatially distributed installations

(75) Inventors: Eckhard Kruse, Heidelberg (DE); Zaijun Hu, Weinheim (DE); Yauheni Veryha, Mannheim (DE); Jens Doppelhammer, Ladenburg (DE); Werner Schmidt, Heddesheim (DE); Johan Andersson, Vaesteras (SE); Jeffrey E. Harding, Concord, OH (US)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD., Zurich (CH)

(21) Appl. No.: 10/567,256

(22) PCT Filed: Apr. 27, 2004
(86) PCT No.: PCT/EP04/04408

§ 371 Date: Jul. 26, 2006

(30) Foreign Application Priority Data
Aug. 9, 2003 (DE) 103 36 648.2

(51) Int. Cl. G06F 15/177

(52) U.S. Cl. 709/220; 709/222

(57) ABSTRACT

The invention relates to a system and method for web-based monitoring and control of distributed installations, with at least one web client which interchanges data/information with web servers in the respective distributed installation via communications links, where the at least one web client has applications and an integration layer for this purpose which execute, show and/or display the data/information interchange with the distributed installations.

The invention relates to a system and a method for web-based monitoring and control of a plurality of distributed technical installations, in accordance with claims 1 and 11.

With the increasing spread of communication via the Internet, new web technologies are also being used to an increasing extent in new fields of application such as automation engineering, for example within the context of web-based operation, monitoring or maintenance of technical installations.

To this end, the technical installations are usually expanded with a web server and appropriate software components, so that data/information in the installations can be transmitted via the Internet or an internal network in order to display them, for example in a superordinate installation, also called web client below, in the form of HTML pages and to modify them or in order to use special web services to access the data in the distributed installations.

Known methods for web-based access to data/information from distributed technical installations have the drawback, however, that they always consider an installation in isolation from the other installations. Often, data/information from a plurality of installations are of interest within a company and have a certain relationship with one another possibly such that, by way of example, it is important to display the sum of the free capacities of all the installations in the company.

Using the existing methods for web-based access to data/information in spatially distributed installations, the data/information in the distributed installations are shown in separate displays. Although it is possible to show the data/information, transmitted by the distributed installations via the Internet, from a plurality of distributed installations simultaneously, for example by opening a plurality of browsers, it is not possible to logically combine these data/information in a particular format or alternatively in a particular arrangement, to show their logic relationships correctly and to assemble them into an integral display.

The invention is based on the object of specifying a system and a method for web-based monitoring and control of a plurality of distributed technical installations, particularly from automation systems, where data/information in the distributed technical installations can be interchanged, can be combined into a uniform structure and can be shown integrally in a user interface.

The invention achieves this object by means of a system for web-based monitoring and control of a plurality of distributed technical installations having the features specified in claim 1.

Advantageous refinements and a method for web-based monitoring and control of a plurality of distributed technical installations are specified in further claims.

The basis for web-based monitoring and control of a plurality of spatially distributed technical installations, particularly in automation engineering, is a piece of integral software which is stored in a superordinate installation, also called client or web client below, and which acts as an intermediate layer between other software parts, said intermediate layer using a communication link to interchange and evaluate data/information about the respective web server in the distributed installation.

To this end, the inventive system has at least one web client which, besides application programs or applications, called applications below, has an integration layer with the integral software. The integration layer in the web client uses communication links, such as the Internet or an internal network, to communicate with the web servers in the respective distributed installations using representative services stored in the web client, which are known as client proxies.

The invention also relates to a method for web-based monitoring and control of distributed installations, where the at least one web client interchanges data/information with web servers in the respective distributed installation using the client software which is integral in the web client's integration layer and which acts as an intermediate layer between other software parts.

The invention advantageously combines the data/information which the distributed technical installations interchange among one another in a uniform structure, shows them integrally in a user interface and logically combines them such that their logic relationships are shown correctly.

In addition, the inventive method is developed particularly advantageously by virtue of the distributed installations storing data structures which have references with pointers to data structures in further distributed installations.

To this end, the data/information are first of all transmitted from a first installation in the “home installation” to the integration layer of the web client. The software contained in the integration layer evaluates the data/information so as to determine whether they contain pointers to further, “federated” installations. Each pointer to a federated installation is evaluated by setting up a connection to the associated web server in the federated installation and loading the referenced data into the client.

In one advantageous embodiment of the invention, the evaluation of the pointers to the federated installations is executed recursively if the federated installation in turn has pointers to further distributed installations. Suitable abortion criteria, such as the ascertainment of maximum depths of recursion, are used to ensure that no continuous loops are executed in the case of cyclic references.

In line with a further advantageous refinement of the invention, the data loaded into the web client from the distributed installations are combined by the client intermediate layer into a uniform, integral representation. This representation is optionally used by the applications for display or for continued interaction. This ensures that the view and handling of the data objects compiled from a plurality of installations do not differ or differ only slightly from operation of a single installation. The current application is independent of whether the data come from one or more systems, since the intermediate layer combines and conditions the data as appropriate in the background, as it were. The presence of the intermediate layer between the software parts prevents applications from needing to be changed, for example, or a temporary store needing to be added in order to interchange data between the distributed installations.

The allocation of a unique system identifier for each data object ensures that when the objects are handled the communication takes place with the respective installation from which the data object is coming.

The use of references between the distributed installations and the option of resolving the references only following a request by the web client also mean that only the respective corresponding home installation or federated installation is addressed in order to handle the individual data objects.

This has the advantage that all of the objects from all the installations can be shown uniformly in freely configurable displays without simultaneously having to set up a uniform full model of the entire stock of data from all the installations at one location.

The concept of the references means that no central data management is required. Rather, the data in the distributed installations are stored locally and are compiled and transmitted in suitable fashion only when required.

It is also advantageously possible to use different application versions, particularly different software versions, on the individual installations, that is to say at server level, since representatives of the respective installations which are stored on the web client, which are known as client proxies, are loaded, for the purpose of communication with the respective installations, directly from the respective installation's web server.

The invention and also advantageous refinements and improvements of the invention will be explained and described in more detail using exemplary embodiments shown with reference to the following figures of the drawing, in which:

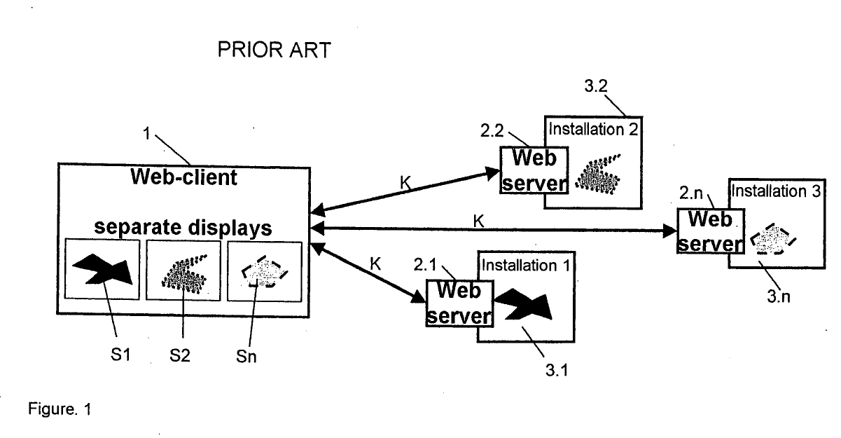

FIG. 1 shows a system for web-based monitoring and control of a plurality of spatially distributed technical installations based on the prior art,

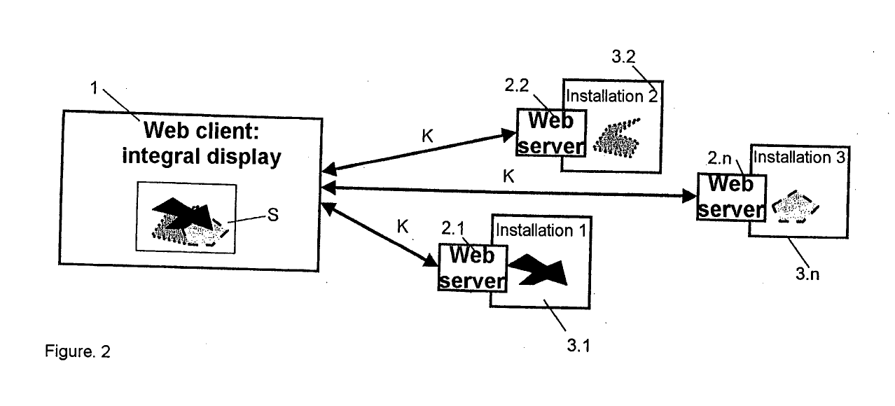

FIG. 2 shows an embodiment of the inventive system for web-based monitoring and control of a plurality of spatially distributed technical installations,

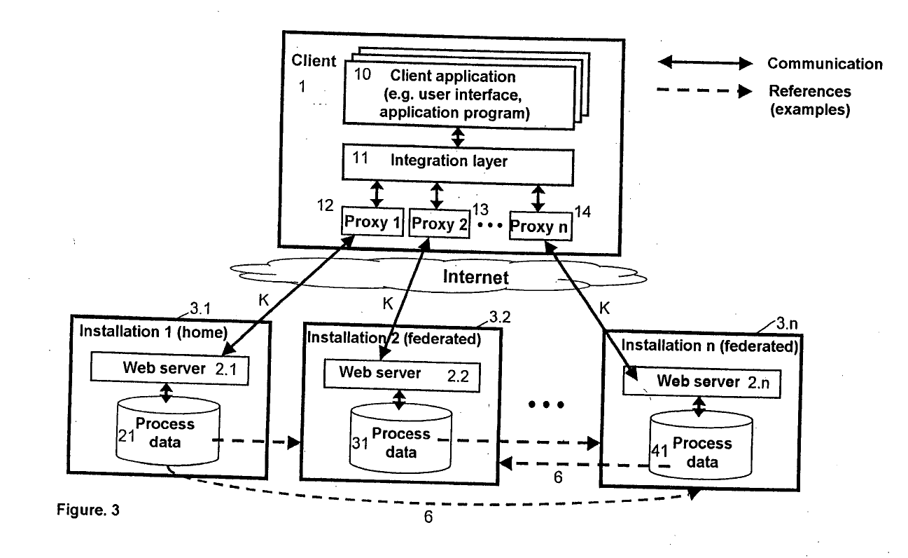

FIG. 3 shows an exemplary overview of the architecture of the inventive system,

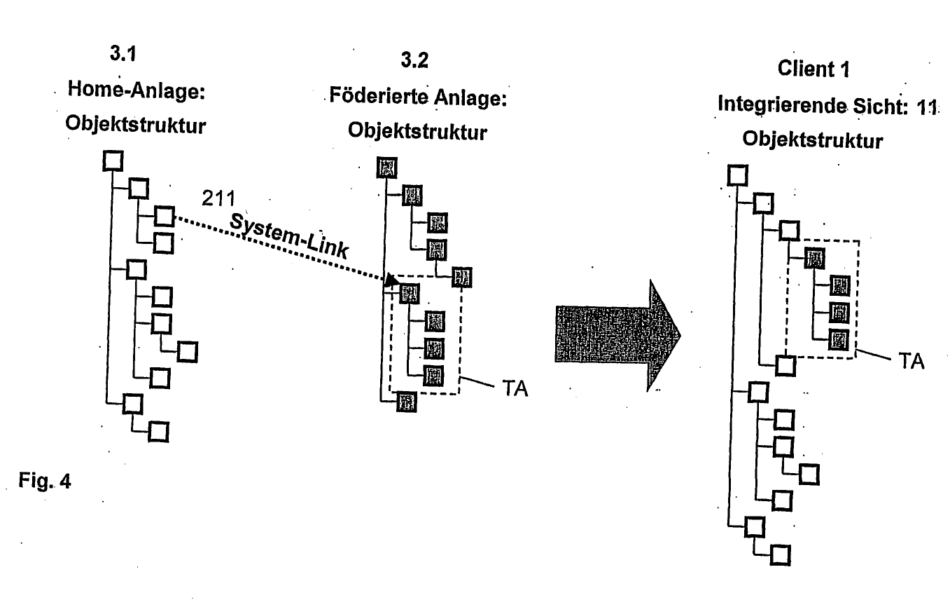

FIG. 4 shows an exemplary embodiment of the integration of data structures from a first installation and from an installation which is subordinate to the first-installation, and

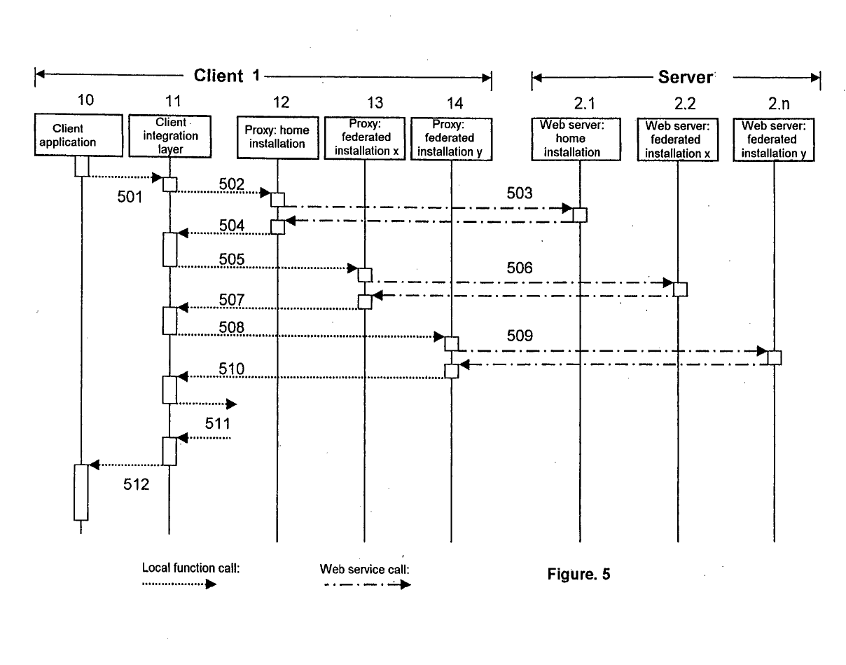

FIG. 5 shows a procedure for web-based monitoring and control of a plurality of spatially distributed technical installations.

FIG. 1 shows a system for web-based monitoring and control of a plurality of spatially distributed technical installations 3.1, 3.2, . . . 3.n based on the prior art, with at least one web client 1, where the technical installations 3.1, 3.2, . . . 3.n each comprise a web server 2.1, 2.2 . . . 2.n which interchanges data/information with the web client 1 via a communication link K, for example the Internet.

In the web client 1, separate displays S1, S2, Sn are shown for the various distributed installations 3.1, 3.2, . . . 3.n, and these displays store the data/information from the respective installations 3.1. 3.2, . . . 3.n. To this end, the displays are loaded from the server, for example, or are generated on the basis of the data/information from the server.

FIG. 2 shows an embodiment of the inventive system for web-based monitoring and control of a plurality of spatially distributed technical installations 3.1, 3.2, . . . 3.n, where a superordinate installation 1, called client or web client below, stores components which provide a uniform integral display S of the data/information in the distributed installations, combine the data/information into a uniform structure and show and/or display them integrally in a user interface.

The data/information interchange between the client 1 and the distributed installations 3.1, 3.2, . . . 3.n is executed via communication links K and the web servers 2.1, 2.2, . . . 2.n which are present in the distributed installations 3.1, 3.2, . . . 3.n.

The client 1 is preferably in the form of a typical web client with a web browser without any further special integrated software.

FIG. 3 shows an exemplary overview of the architecture of the inventive system. Using the communication links K, for example the Internet or an internal network, the web client 1 communicates with the web servers 2.1, 2.2, . . . 2.n of the distributed technical installations 3.1, 3.2, . . . 3.n. To this end, one or more applications 10 are loaded into the web client 1 from a “home server” in a first installation 3.1, preferably upon operation for the first time and usually just once, for example as application programs for installation control with the associated user interfaces. The applications 10 use the communication links K to interchange data/information with the installations 3.1, 3.2, . . . 3.n and to request an integrated display S of the data from the installations 3.1, 3.2, . . . 3.n.

To this end, the applications 10 use an integration layer 11, and hence connected representative services 12, 13, 14 on the client, which are known as proxies, and also the communication link K to communicate with the distributed installations 3.1, 3.2, . . . 3.n, for example in order to request data from the installations 3.1, 3.2, . . . 3.n or in order to transmit control signals to the installations 3.1, 3.2, . . . 3.n. The client proxies 12, 13, 14 which are typically provided for the client 1 to communicate with the installations 3.1, 3.2, . . . 3.n are to this end loaded from the appropriate web servers 2.1, 2.2 . . . 2.n of the distributed technical installations 3.1, 3.2, . . . 3.n and provide the communication link K between the client 1 and the web servers 2.1, 2.2 . . . 2.n of the installations 3.1, 3.2, . . . 3.n.

The client components, such as the proxies 12, 13, 14, the integration layer 11 and the client applications 10, are typically in the form of software components which are loaded, automatically installed and executed using standard web mechanisms, such as the mechanisms known by the commercial names Microsoft Active-X Controls, Microsoft NET components or Java Applets.

The communication between the client 1 and the w installations 3.1, 3.2, . . . 3.n, particularly the data requests or data calls, is executed using a web service or using SOAP (Simple Object Access Protocol) calls, for example.

The data/information in the installations 3.1, 3.2, . . . 3.n, which are described by objects, also called data objects below, are project data, measured values or states of the distributed installations 3.1, 3.2, . . . 3.n, for example, and are available in separate databases 21, 31, 41 in the installations 3.1, 3.2, . . . 3.n or are generated in real time, for example on the basis of the values measured by sensors. The data objects from the databases 21, 31, 41 are transmitted to the client 1 via the web server 2.1, 2.2, . . . 2.n of the respective installation 3.1, 3.2, . . . 3.n and the communication link K upon a request by the client 1.

The data objects stored in the databases 21, 31, 41 of the respective installations 3.1, 3.2, . . . 3.n have references 6 with pointers, known as system links 6, to data, structures and/or substructures for the other distributed installations 3.1, 3.2, . . . 3.n which are also called federated installations.

The function of the integration layer 11 provided for the uniform conditioning and showing of the data/information comprises resolution of the references 6 of the data loaded from the web servers 2.1, 2.2 . . . 2.n. In addition, the integration layer 11 uses the various proxies 12, 13, 14 to reload the data/information from the appropriate federated installations 3.2, . . . 3.n. The uniform display S of the data/information which this provides is then supplied to the client applications 10, particularly to the application programs and/or graphical user interfaces, and is shown.

In addition, the integration layer 11 is set up to preprocess the data requests from the client applications 10 in order to request the data from the respective proxies 12, 13, 14 and hence from the web servers 2.1, 2.2 . . . 2.n of the associated installations 3.2, . . . 3.n.

In one preferred embodiment, a first installation 3.1 is defined as “home installation”, which thus forms a central point of entry into the inventive system. The installations 3.2, . . . 3.n connected to the home installation 3.1 are the installations which are federated to the home installation 3.1. The home installation 3.1 contains the root object for the object hierarchies of the federated displays and is able to provide user-dependent configurations and settings for the entire installation system.

In FIG. 4, the integration of data structures in a first installation 3.1, known as the home installation, and in an installation 3.2 . . . 3.n which is subordinate to the first installation, called the federated installation, uses an exemplary embodiment to illustrate how the data structures in a plurality of distributed installations 3.1, 3.2, . . . 3.3 are assembled into an integral display S.

The displayed structures denote data models which can be assembled as desired from data structures or data substructures in the installations.

Assuming that the data in the installations 3.1, 3.2 . . . 3.n are described by data objects which are preferably arranged in hierarchic structures, a data model of an installation 3.1, 3.2 . . . 3.n in this case sometimes contains a multiplicity of different structures where objects are also stored a plurality of times in the structures at various locations. In this context, the data objects represent both physical and logical components of the installation 3.1, 3.2 . . . 3.n, for example.

The various structures represent various displays for the installation, for example the three-dimensional design or the logic relationship between the objects within a modeled process. The properties of particular objects are in turn described by “aspects”, with, in particular, the hierarchic relationships between the objects also being described by aspects.

In order to describe the references 6 from the home installation 3.1 to the federated installations 3.2, . . . 3.n, for example, one particular embodiment introduces special aspects which clearly describe an appropriate substructure in a federated installation 3.2, . . . 3.n and allocate it to an associated object.

FIG. 4 shows a home installation 3.1 and a second, federated installation 3.2 which interchange data with the integration layer 11 of the client 1. For the purpose of data interchange between the home installation 3.1 and the second, federated installation 3.2, a system reference 211, for example a system link, points from an object from the home installation 3.1 to a substructure in the federated installation 3.2.

To give a better overview, just a single structure, called object structure below, with few objects and without aspects is shown for each of the installations 3.1, 3.2, . . . 3.n, but further structures or substructures may also be shown in connection with the special aspects in the installations' respective object structures.

On the client 1, the integration layer 11 is used to generate an all-encompassing, integral display 110 of the data in the two installations 3.1, 3.2, . . . 3n. The referenced subsection TA of the home installation 3.1 with the federated installation 3.2 is in this case incorporated into the structure in the home installation 3.1.

Advantageously, the data objects are stored in the client's display 110 such that the references 6 are resolved only following a request by the client 1. Thus, to handle the individual data objects, the respective appropriate home or federated installation continues to be addressed. As a result, all of the objects in all the installations 3.1, 3.2, . . . 3n can be shown uniformly in freely configurable displays, and it is not necessary for a uniform complete model of the entire stock of data in all the installations 3.1, 3.2, . . . 3n to be set up at one location.

In one particular embodiment, by way of example, all the data in the distributed installations 3.1, 3.2, . . . 3n are loaded onto the client 1 or onto the web server 2.1, 2.2, . . . 2.n of just a single distributed installation 3.1, 3.2, . . . 3n and the entire structure is set up in advance on the web server 2.1, 2.2, . . . 2.n of the single distributed installation 3.1, 3.2, . . . 3n, even though just a small part of the overall structure needs to be displayed on the client 1.

The exemplary embodiment in FIG. 4 shows just a simplified version of the integration of data structures in the distributed installations 3.1, 3.2, . . . 3n. In advantageous developments of the invention, it is also possible to specify more complex, multistage logic combinations between the numerous structures in a large number of different installations.

The client components 10, 11, 12 of the web client 1 are automatically loaded, automatically installed and executed using the standard web mechanisms. To this end, a connection to the home installation 3.1 is set up via which the components 10, 11, 12 needed in the client are automatically loaded into the client 1 from the web server 2.1 of the home installation 3.1 and can thus be executed on the client 1.

Accordingly, the web server 2.1 of the home installation 3.1 holds the client integration layer 11 for downloading to the web client 1. For the federated installations 3.2, . . . 3.n, on the other hand, it is sufficient if they provide proxy components for communication with the web client 1. If the communication of the federated installations 3.2, . . . 3.n is executed in the same way as with the home installation 3.1 then in one particular embodiment the proxies 12, 13, 14 which have already been downloaded to the web client 1 beforehand, which are also called proxy program components below, are also used, for example.

If the web client 1 has not yet stored the respectively required proxy program components 12, 13, 14, they are downloaded when required, that is to say when an application program requires a proxy 12, 13, 14 in order to download itself data from a server.

The communication by the proxies 12, 13, 14 with the respective installation 3.1, 3.2, . . . 3.n is preferably executed such that the proxies 12, 13, 14 provide a uniform interface to the integration layer 11. The integration layer 11 can thus be used in a heterogeneous system landscape in which the installations 3.1, 3.2, . . . 3.n operate with partly different software versions and communication protocols, for example.

FIG. 5 shows a procedure for web-based monitoring and control of a plurality of spatially distributed technical installations 3.1, 3.2 . . . 3.n with at least one web client 1, which has applications 10, an integration layer 11 and proxies 12, 13, 14 for a home installation 3.1 and for at least one federated installation 3.2, . . . 3.n, and with web servers 2.1, 2.2 . . . 2.n in the distributed installations 3.1, 3.2 . . . 3.n using method steps 501-512, where exemplary data interchange between the client 1 and the distributed installations 3.1, 3.2 . . . 3.n and also the resolution of references 6 between a plurality of federated installations 3.2 . . . 3.n are shown.

The data interchange between the applications 10, the integration layer 11 and the proxies 12, 13, 14 for the distributed installations 3.1, 3.2, . . . 3.n is executed using local function calls, and the data interchange between the proxies 12, 13, 14 and the web servers 2.1, 2.2 . . . 2.n in the distributed installations 3.1, 3.2, . . . 3.n is executed using web service calls.

On the client 1, this is done by loading at least one application 10, for example with a user interface for visually displaying the entire system comprising the distributed installations 3.1, 3.2 . . . 3.n.

In a first step 501, the application 10 uses a local function call to request an integrated display S of the data in the home installation 3.1 and in the federated installations 3.2, . . . 3.n from the integration layer 11.

The subsequent steps describe how the integration layer 11 then makes requests to the web servers 2.1, 2.2, . . . 2.n in the distributed installations 3.1, 3.2 . . . 3.n in order to compile the data objects for the display S in steps, preferably recursively, in this manner. In this context, the integration layer does not communicate directly with the web servers 2.1, 2.2, . . . 2.n, but rather by means of the client representatives 12, 13, 14.

In a second step 502, the integration layer 11 in the client 1 transmits a request to a first proxy 12 for the home installation 3.1.

In a third step 503, the first proxy 12 for the home installation 3.1 requests the desired data structure from the associated web server 2 in the home installation 3.1 using a web service call, and in a fourth step 504 the data in the data structure are transmitted back from the web server 2.1 in the home installation 3.1 via the first proxy 12 for the home installation 3.1 to the client integration layer 11.

The integration layer 11 is used to ascertain whether the data in the desired data structure have references 6 to other installations 3.2, . . . 3.n. If a reference 6 points to data structures within a federated installation 3.2, for example, then in a fifth step 505 and in a sixth step 506 appropriate requests are used to load the data from the responsible server 2.2 in the federated installation 3.2 using the associated second representative 13, and these data are transmitted to the integration layer 11 in the client 1 in a seventh step 507.

In the integration layer 11, the data are assembled into a uniform data structure. This operation can be repeated as often as desired and can optionally be executed in steps, which is shown by way of example in FIG. 5 in the further steps 508 to 511 such that when a further reference 6 refers to the data structures within a further federated installation 3.n an appropriate request is transmitted from the integration layer 11 via a third proxy 14 for the further federated installation 2.n in an eighth step 508 and to the web server 2.n in the further federated installation 2.n in a ninth step 509. In turn, the web server 2.n in the further federated installation 2.n uses the associated third representative 14 in a tenth step 510 to transmit the data from the web server 2.n in the further federated installation 3.n to the integration layer 11 in the client 1.

By transmitting the data objects from the servers 2.1, 2.2, . . . 2.n in the distributed installations 3.1, 3.2 . . . 3.n, further references 6 are also loaded which need to be resolved again, so that completely filling a desired display S with data may involve a server being contacted several times or in circular fashion. If circular references are present, continuous loops within the procedure must be avoided. This is done by introducing a suitable abortion criterion which, for example, permits just a maximum depth of recursion for references 6.

If all of the data to be interchanged in the distributed installations 3.1, 3.2 . . . 3.n are stored in the web client 1 or if an abortion criterion has been reached, the integration layer 11 transmits the data display S generated in this manner to the calling client application 10 in a final step 512.

Further requests from the client application 10, particularly for the purpose of requesting further data structures or for the purpose of modifying data objects within the loaded data structures, are likewise transmitted to the integration layer 11 in the client 1 and are forwarded using the above-described method in this manner to the responsible proxies 12, 13, 14 for the purpose of communication with the respective distributed installation 3.1, 3.2 . . . 3.n.

1. A system for web-based monitoring and control of distributed installations with at least one web client which interchanges data/information with web servers in the respective distributed installation via communication links (K), and wherein the at least one web client comprises applications and an integration layer which execute, show and/or display the data/information interchange with the distributed installations.

2. The system as claimed in claim 1, wherein the integration layer is formed by a piece of integral software for data interchange and/or for data evaluation with the distributed installations.

3. The system as claimed in claim 1, wherein the purpose of data interchange between the web client and the distributed installations is served by virtue of the web client containing representative services for communication by the web servers in the respective distributed installations said representative services communicating with the integration layer and with the web servers in the respective distributed installations.

4. The system as claimed in claim 1, wherein the applications stored in the web client are applications or application programs which show and/or display the data which have been combined into a uniform structure using the integration layer.

5. The system as claimed in claim 1, wherein the integration layer preprocesses data requests from the applications.

6. The system as claimed in claim 1, wherein the applications, the integration layer and the representative services are in the form of software components and can be installed and executed automatically using standard web mechanisms.

7. The system as claimed in claim 1, wherein the distributed installations store data structures with references, where the references contain pointers to data, structures and/or substructures in further distributed installations.

8. The system as claimed in claim 1, wherein the integration layer executes the evaluation of the pointers with further distributed installations recursively or cyclically.

9. The system as claimed in claim 8, wherein abortion criteria are provided for the purpose of avoiding continuous loops in the case of cyclic execution of the of the pointers.

10. The system as claimed in claim 1, wherein the data interchange between the applications, the integration layer and the representative services in the distributed installations can be executed using local function calls, and the data interchange between the representative services and the web servers in the distributed installations be executed using web service calls.

11. A method for web-based monitoring and control of distributed installations with at least one web client which interchanges data/information with web servers in the respective distributed installation via communication links (K), and the at least one web client stores applications and an integration layer which are used to execute, show and/or display the data/information interchange with the distributed installations.

12. The method as claimed in claim 11, wherein the integration layer is formed by a piece of integral software for data interchange and/or for data evaluation with the distributed installations.

13. The method as claimed in claim 11, wherein the purpose of data interchange between the web client and the distributed installations is served by virtue of the web client storing representative services which communicate with the integration layer and with the web servers in the respective distributed installations.

14. The method as claimed in claim 11, wherein the data which have been combined into a uniform structure using the integration layer are shown and/or displayed using the applications stored in the web client.

15. The method as claimed in claim 11, wherein the purpose of requesting data from the web servers in the distributed installations is served by virtue of the applications being used to preprocess requests from the integration layer.

16. The method as claimed in claim 10, wherein the application, the integration layer and the representative services are in form of software components and are installed and executed automatically using standard web mechanisms.

17. The method as claimed in claim 11, wherein the distributed installations store data structures with references, the references containing pointers to data, structures and/or substructures in further distributed installations.

18. The method as claimed in claim 11, wherein pointers in the respective distributed installation to further distributed installations involve the evaluation of the pointers of the distributed installations being executed recursively or cyclically using the integration layer.

19. The method as claimed in claim 18, wherein cyclic execution of the evaluation of the pointers involves the procedure being interrupted by means of suitable abortion criteria and a generated data display being transmitted to the calling client application.

20. The method as claimed in claim 11, wherein the references between the distributed installations are resolved only following a request by the web client.

21. The method as claimed in claim 11, wherein the data/information in a first installation are first loaded in the integration layer and evaluated in relation to pointers with further distributed installations.

22. The method as claimed in claim 11, wherein the data interchange between the applications, the integration layer and the representative services in the distributed installations is executed using local function calls, and the data interchange between the representative services and the web servers in the distributed installations is executed using web service calls.
